(19) United States
(12) Patent Application Publication
(10) Pub. No.: US 2006/0123596 A1
(43) Pub. Date: Jun. 15, 2006

(54) Hinge assembly for a foldable electronic device

(75) Inventors: Rui-Hao Chen, Shenzhen (CN); Peng-Jin Ge, Shenzhen (CN); Xing-Huang Luo, Shenzhen (CN); Shui-Yuan Qin, Shenzhen (CN); Gang Yang, Shenzhen (CN); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/298,126

(22) Filed: Dec. 9, 2005

(30) Foreign Application Priority Data
Dec. 9, 2004 (CN) 200410077423.X

(51) Int. Cl. E05D 11/08

(52) U.S. Cl. 16/337

(57) ABSTRACT

A hinge assembly (100) includes a shaft (10), a cam (20), and an elastic member (30). The shaft is in the form of a rod and provided with a projection (16). The cam includes a body (21) and a center cavity (23). The body of the cam defines a cam face (22) at one end thereof, and the projection of the shaft is engaged with the cam face. The shaft travels through the center cavity of the cam. One end of the elastic member biases relative to a distal end portion of the shaft, and an opposite end of the elastic member abuts an end of the cam opposite the cam face.

### BACKGROUND OF THE INVENTION

1. Field of the Invention

The present invention generally relates to hinge assemblies and, more particularly, to a hinge assembly for hinging together housings of foldable electronic devices such as mobile telephones, electronic notebooks, and so on.

2. Discussion of the Prior Art

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body The other housing, called the cover, normally contains fewer electronic components than the body Other foldable electronic devices have all the electronics in the body, thus the cover contains no electronics and serves only to cover a keypad and a display of the body. Various types of hinge assemblies are used to join a body and a cover of a foldable electronic device, so that the cover can unfold up from and fold down upon the body.

As represented in FIG. 4, a conventional hinge assembly for a foldable mobile telephone 700 includes a spring 762 and two hinge pins 764, 768. The hinge pins 764, 768 are disposed in a tubular hinge arm 742 formed at an end of a cover 74, and corresponding bushings 722 are formed in a body 72. The spring 762 is positioned between the hinge pins 764, 768, and at all times forces the hinge pins 764, 768 outwardly from the cover 72 toward the body 74.

Such a hinge assembly is suitable for some foldable mobile telephones. However, the hinge assembly includes a variety of individual pieces that must be installed within the foldable mobile telephone when the foldable mobile telephone is assembled. This type of hinge does not meet the growing trend for foldable mobile telephone manufacturers to use integrated one-piece hinge assemblies, which can be quickly and easily press-fitted into foldable mobile telephone sub-assemblies during manufacturing.

What is needed, therefore, is a hinge assembly which is integrated and provides easy assembly.

### SUMMARY

In a preferred embodiment herein, a hinge assembly for a foldable electronic device is provided. The hinge assembly includes a shaft, a cam, and an elastic member. The shaft is in the form of a rod and provided with a projection. The cam includes a body and a center cavity. The body of the cam defines a cam face at one end thereof, and the projection of the shaft is engaged with the cam face. The shaft travels through the center cavity of the cam. One end of the elastic member is effectively resisted by the shaft, and an opposite end of the elastic member abuts an end of the cam opposite the cam face.

Other advantages and novel features of various embodiments will become more apparent from the following detailed description thereof when taken in conjunction with the accompanying drawings.

### BRIEF DESCRIPTION OF THE DRAWINGS

Other aspects of the hinge assembly can be better understood with reference to the following drawings. The components in the drawings are not necessarily scale, the emphasis instead being placed upon clearly illustrating the principles of the hinge assembly. Moreover, in the drawings, like reference numerals designate corresponding parts throughout the several views.

FIG. 1 is an isometric view of a foldable electronic device with a hinge assembly, according to a first preferred embodiment;

FIG. 2 is an enlarged, exploded, isometric view of the hinge assembly of FIG. 1;

FIG. 3 is an assembled, isometric view of the hinge assembly of FIG. 2; and

FIG. 4 is an exploded, isometric view of a conventional hinge assembly for a foldable mobile telephone.

### DETAILED DESCRIPTION OF THE PREFERRED EMBODIMENTS

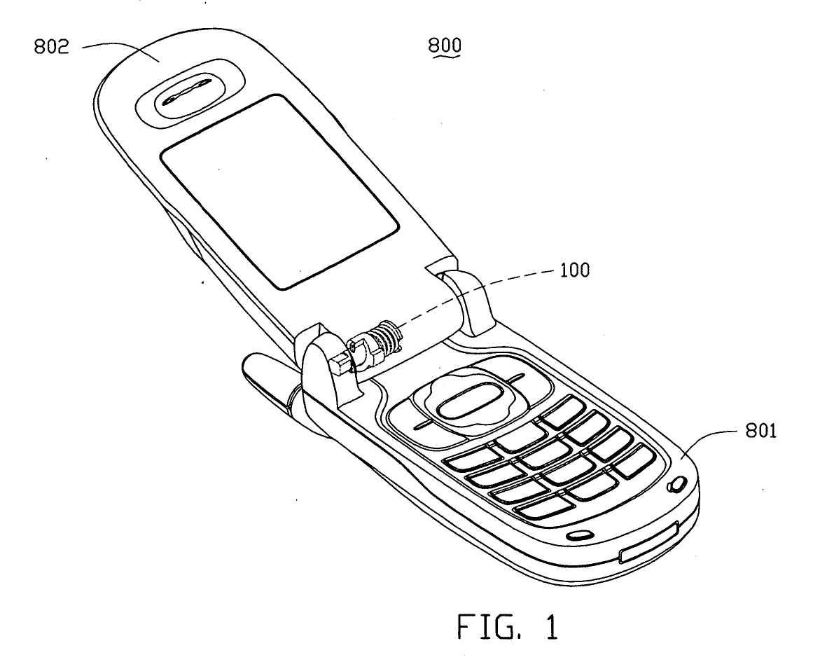

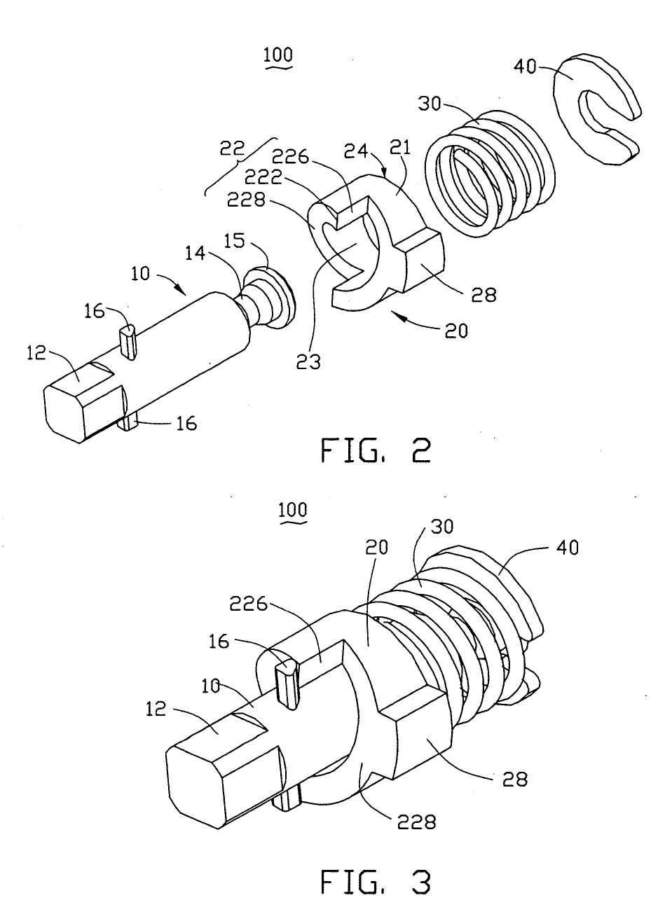

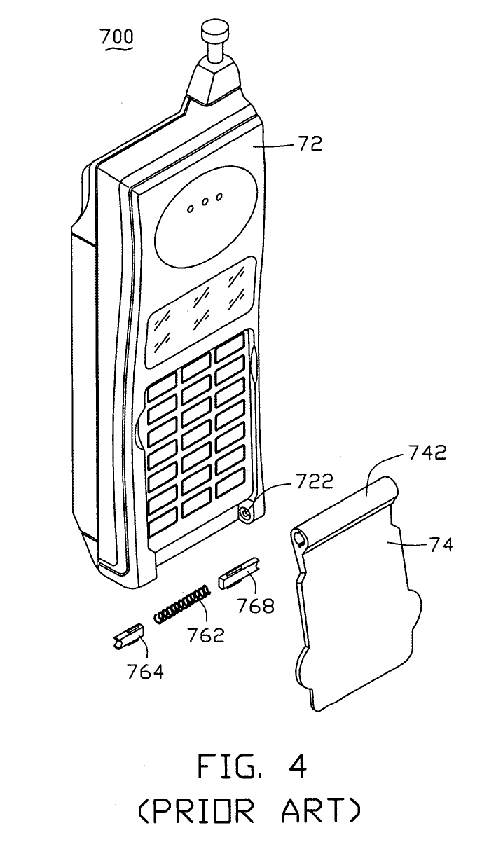

FIGS. 1-3 show a hinge assembly 100 according to a preferred embodiment of the present hinge system. The hinge assembly 100, in the embodiment illustrated, is used to interconnect a body 801 and a cover 802 of a foldable electronic device 800. The hinge assembly 100 includes a shaft 10, a cam 20, a compression spring 30, and a disk 40. The shaft 10 extends through the cam 20, the compression spring 30, and the disk 40, thereby integrating the hinge assembly 100 into a complete unit. While the hinge assembly 100 is shown incorporated into the foldable electronic device 800, it is to be understood that the hinge assembly 100 or obvious variations thereof may prove useful in other work environments (e.g., cabinet doors) as well.

The shaft 10 is essentially in the form of a round rod. A keyed head 12 is formed at a first end of the shaft 10, and an annular slot 14 and a corresponding stop plate 15 are formed at an opposite second end of the shaft 10. The stop plate 15 may be either integrally or separately attached as part of the shaft 10. The keyed head 12 is an irregular polygonal block. The keyed head 12 is engaged with the body 801 of the foldable electronic device 800 so that the shaft 10 is rotatable with the body 801. A pair of projections 16 is formed on two opposite sides of the shaft 10 and adjacent the keyed head 12. The projections 16 are advantageously generally pole-shaped and are essentially diametrically aligned with each other. Further advantageously, the pole-shape and the positioning of the projections 16 (i.e., their configuration) is chosen so as to facilitate movement thereof relative to the cam 20. The projections 16 and the shaft 10 are either integral or separately attached. If separately attached, the shaft 10 could have a pair of holes defined in a periphery thereof, and the projections 16 of the shaft 10 could be respectively secured in the holes. Whether or not mounting holes are employed, the projections 16 could be mechanically or metallurgically fastened to the shaft.

The cam 20 is essentially in the form of a modified, hollow cylinder and includes a body 21 and a center cavity 23. The center cavity 23 is formed through the body 21 along a center axis of the cam 20. The center cavity 23 is engaged with the shaft 10, so that the cam 20 is both axially movable and rotatable relative to the shaft 10. A first end of the body 21 has a cam face 22, and an opposite second end of the body 21 has a flat face 24. The cam face 22 has two vertical slopes 226 and two angled slopes 228. Each angled slope 228 spans about half a circumference of the body 21 and is advantageously angled (roughly 15°-50° relative to the flat face 24) to promote a gradual yet significant change in loading in the compression spring 30 upon rotation of the cam 20. Each vertical slope 226 is essentially parallel to the center axis of the cam 20. In an alternative embodiment, each angled slope 228 spans about 160 degrees of a circumference of the body 21. The slopes 226, 228 are alternatively formed, thereby establishing a pair of respective ridges 222. A protrusion 28 is formed on a periphery of the body 21. The protrusion 28 is cuboid and is engaged with the cover 802 of the foldable electronic device 800 so that the cam 20 is rotatable with the cover 802.

The compression spring 30 advantageously is made of metal and is spiral-shaped (i.e., a coil spring). The disk 40 is C-shaped and is elastically snap fit and thus secured on the shaft 10 in the annular slot 14. The compression spring 30 abuts against the disk 40. The disk 40 is retained on the length of the shaft 10 by the stop plate 15, even under a force created by the compression spring 30.

In assembly of the hinge assembly 100, the second end of the shaft 10 extends through the center cavity 23 of the cam 20 and the compression spring 30, and the disk 40 is snap fit on the shaft 10 in the annular slot 14. The compression spring 30 is located between the cam 20 and the disk 40. One end of the compression spring 30 abuts against the disk 40. The disk 40, in turn, biases against the stop plate 15 due to the force of the compression spring 30 (i.e., conversely, the compression spring 30 is biased relative to the stop plate 15 in this manner). An opposite end of the compression spring 30 abuts against the flat face 24 of the cam 20. The compression spring 30 is slightly compressed, so that the compression spring 30 continuously presses the cam face 22 of the cam 20 against the projections 16 of the shaft 10. The hinge assembly 100 is thus completely assembled, as shown in FIG. 3. In this position, the projections 16 are respectively located on the angled slopes 228 of the cam 20 adjacent the ridges 222 thereof, and the cover 802 of the foldable electronic device 800 is held in a closed position by a lock mechanism (not shown).

To open the foldable electronic device 800, the lock mechanism is manually unlocked. Hence, the compression spring 30 decompresses and drives the cam 20 to move relative to the shaft 10. The cover 802 is correspondingly rotated up from the body 801 and continuously rotated in an opening direction under the decompression force of the compression spring 30. The cover 802 is thus opened automatically to a fully opened position, a position at which the projections 16 abut against the vertical slopes 226 of the cam 20.

To close the foldable electronic device 800, the cover 802 is manually rotated down toward the body 801. As such, the cam 20 moves relative to the shaft 10. The angled slopes 228 of the cam 20 move relative to the projections 16 of the shaft 10, with the ridges 222 approaching the corresponding projections 16. Concurrently, the flat face 24 of the cam 20 axially moves toward the second end of the shaft 10 (i.e., toward the stop plate 15) and rotates relative to the shaft 10. As a result, the compression spring 30 is compressed. When the foldable electronic device 800 is in a closed position, the cover 802 is held by the lock mechanism.

It is to be understood that the compression spring 30 may alternatively be made of another material (e.g., plastic or rubber) and/or have a different configuration (e.g., leaf spring or resilient cylinder).

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A hinge assembly, comprising:
a shaft in the form of a rod and provided with at least one projection, the shaft having a first end and an opposite second end;
a cam including a body and a center cavity, the body of the cam having a first end and a second end, the body defining a cam face at the first end thereof, the second end of the body being opposite the cam face, the shaft traveling through the center cavity, and the projection of the shaft engaging with the cam face; and
an elastic member, one end of the elastic member biasing relative the second shaft end, and an opposite end of the elastic member abutting the second end of the body of the cam.

2. The hinge assembly as claimed in claim 1, wherein the projection of the shaft is generally pole-shaped.

3. The hinge assembly as claimed in claim 1, wherein the shaft and each projection is one of integrally formed and separately attached.

4. The hinge assembly as claimed in claim 1, wherein each projection is configured so as to facilitate movement thereof relative to the cam face.

5. The hinge assembly as claimed in claim 1, wherein a keyed head is provided at the first end of the shaft, the keyed head being configured for engaging with a first body to be hinged relative to a second body, the keyed head being configured to engage with the first body in a manner such that the shaft is rotatable with the first body.

6. The hinge assembly as claimed in claim 1, wherein the shaft has an annular slot defined in the second end thereof.

7. The hinge assembly as claimed in claim 6, further comprising a disk, the disk being snappingly secured in the annular slot of the shaft.

8. The hinge assembly as claimed in claim 1, wherein the cam is essentially in the form of a modified hollow cylinder, and the center cavity is formed through the body along a center axis of the cam.

9. The hinge assembly as claimed in claim 1, wherein a protrusion is provided on a periphery of the body of the cam, the protrusion being configured for engaging with a device element so that the cam can be rotated with the device element.

10. The hinge assembly as claimed in claim 1, wherein the cam face of the cam has a plurality of slopes.

11. The hinge assembly as claimed in claim 10, wherein the body of the cam defines a flat face at the second end thereof, at least one slope of the cam being angled approximately in the range of 15° to 50° relative to the flat face of the cam.

12. The hinge assembly as claimed in claim 10, wherein at least one slope of the cam spans about a semi-circumference of the body of the cam.

13. The hinge assembly as claimed in claim 1, wherein the elastic member is made of one of metal, rubber, and plastic.

14. The hinge assembly as claimed in claim 1, wherein the elastic member is a compression spring.

15. The hinge assembly as claimed in claim 14, wherein the compression spring is spiral-shaped.

16. A foldable electronic device, comprising:
a cover;
a body; and
a hinge assembly rotatably connecting the cover and the body, the hinge assembly comprising:
a shaft in the form of a rod and provided with at least one projection, the shaft having a first end and an opposite second end;
a cam including a body and a center cavity, the body of the cam having a first end and a second end, the body defining a cam face at the first end thereof, the second end of the body being opposite the cam face, the shaft traveling through the center cavity, and the projection of the shaft engaging with the cam face; and
an elastic member, one end of the elastic member biasing relative the second shaft end, and an opposite end of the elastic member abutting the second end of the body of the cam.
